(19) United States
(12) Patent Application Publication
(10) Pub. No.: US 2002/0031694 A1
(43) Pub. Date: Mar. 14, 2002

(54) Process for the selective electrochemical oxidation of organic compounds

(75) Inventors: F. P.F. Van Berkel, Alkmaar (NL); Mark Duda, Ludwigshafen (DE); Adolf Kuhnle, Marl (DE); G.S. Schipper, Warmenhuizen (NL); Guido Stochniol, Kahl (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DEGUSSA AG, MARL (DE)

(21) Appl. No.: 09/866,638

(22) Filed: May 30, 2001

(30) Foreign Application Priority Data
May 30, 2000 (DE) 10 026 . 941.9

(51) Int. Cl. H01M 8/10; H01M 4/92; H01M 4/90; H01M 4/60; H01M 4/48

(52) U.S. Cl. 429/30; 429/33; 429/40; 429/213; 429/231.1; 429/50

(57) ABSTRACT

A process is provided for the oxidation of an organic compound in an electrochemical cell having an anode, a cathode and an oxygen ion-conducting solid electrolyte, wherein the organic compound is contacted with the anode, wherein the anode contains a mixture of an electroconductive material and a mixed oxide of the formula I

AₗBₘX⁷ₙX⁸ₒX⁹ₚX¹⁰_{q}X¹¹ᵣX¹²ₛOₜ (I)

where

A, B=element of the 1st, 2nd and/or 5th main group and/or the 4th, 5th, 6th, 7th, 8th subgroup of the Periodic Table of the Elements,

X⁷=V, Nb, Cr, W, Ta, Ga and/or Ce,

X⁸=Li, Na, K, Rb, Cs, Be, Mg, Ca, Sr and/or Ba,

X⁹=La, Ce, Pr, Nd, Pm, Sm, Eu, Gd, Tb, Dy, Ho, Er, Tm, Yb, Lu, Cu, Ag, Au, Pd and/or Pt,

X¹⁰=Fe, Co, Ni and/or Zn,

X¹¹=Sn, Pb, Sb and/or Te,

X¹²=Ti, Zr, Si and/or Al, where

l=from 0.001 to 30,

m=from 0.001 to 20,

n=from 0 to 15,

o=from 0.001 to 10,

p=from 0 to 10

q=from 0 to 40

r=from 0 to 10, and

s=from 0 to 80 with the proviso that l+m≧0.01 and l+o≧0.005, and an oxygen- or an N₂O-containing gas is contacted with the cathode.

### BACKGROUND OF THE INVENTION

1. Field of the Invention

The invention relates to an electrochemical process for the selective preparation of partially oxidized organic compounds.

2. Discussion of the Background

The direct selective oxidation of organic compounds hitherto has been possible only in a few cases, since the partially oxidized products are usually more reactive than the starting materials used, the result being complete oxidation with the formation of carbon dioxide. The problem of direct oxidation of alkanes and aromatic compounds in particular has not, so far, been satisfactory.

One exception is the direct oxidation of n-butane to produce maleic anhydride. Here, however, a decisive role is played by the oxidation product being stabilized by ring formation.

In the partial direct oxidation of unreactive organic compounds, many attempts are directed to the development of novel heterogeneous catalysts. In this field, however, the yield of the partially oxidized product is often not sufficient for industrial purposes.

Comparatively less attention is being paid to electrochemical partial oxidation. On the contrary, the development work in this field is directed to the utilization of the total oxidation of suitable compounds for the production of electrical energy in fuel cells.

One example for the electrochemical oxidation of organic compounds is described in U.S. Pat. No. 4,329,208 relating to the oxidation of ethene to ethylene oxide. This oxidation takes place at an anode consisting of silver or a silver alloy by means of a solid electrolyte system comprising zirconium oxides.

Another process relating to the electrochemical oxidation of organic compounds is described in U.S. Pat. No. 4,661,422. Here, hydrocarbons are oxidized at a metal/metal oxide anode in a fused salt as the electrolyte. The fused salt comprises carbonate, nitrate or sulfate salts. The cathode is composed of mixed oxides of metals of the groups I B, II B, III A, V B, VI B, VII B and VIII B of the Periodic Table of the Elements.

Takehira et al., in Catalysis Today 1995, 25, 371, studied the partial oxidation of propene in a set-up similar to fuel cells. The electrolyte used was Y-stabilized ZrO₂. The anode material employed was Au supporting an Mo—Bi mixed oxide as the catalyst, and the cathode material was Ag. The reaction temperature was 475° C.

The yield of the oxidation product desired in each particular case is so low, as a rule, that none of these processes is industrially significant. Here too, the problem of total oxidation of the organic substrate to carbon dioxide has not yet been solved. Moreover, the electrolyte acts as an “oxygen pump”, i.e. the oxygen required for the oxidation is reduced at the cathode and then, in ionic form, migrates to the anode through the electrolyte. The anode compartment contains only the substrate to be oxidized and optionally an inert gas. Feeding oxygen into the anode compartment does not result in an increased yield of the desired oxidation product.

Another drawback is that the reaction temperature is determined by the oxygen conductivity of the electrolyte. Only at temperatures distinctly above the optimum temperatures for such oxidation reactions do the electrolytes employed have adequate conductivity. This fact provides a partial explanation of the low selectivity of the processes investigated.

Processes employed in fused salts as the electrolyte necessarily involve reaction temperatures which are so high (up to 750° C.) that decomposition of the products is virtually inevitable. Processes of this type are unsuitable for the preparation of thermally unstable compounds (e.g. Michael systems).

The discovery of the NEMCA effect (Non Faradaic Electrochemical Modification of Catalytic Activity) opens up the possibility of developing more economical electrochemical processes. Vayenas et al., in “Studies in Surface Science and Catalysis”, R. K. Grasselli, S. T. Oyama, A. M. Gaffney, J. E. Lyons (Editors), 110, 77 (1997) and Science (1994), 264, 1563, describe an electrochemical process, based on a conductive, porous metal (oxide) film on a solid electrolyte such as Y-stabilized ZrO₂. Gas tight separation of the anode and cathode compartment is here no longer necessary, and the oxidant can be fed into the anode compartment at the same time. It was found, however, that the main product of the oxidation, carbon dioxide, still results from the total oxidation of the substrate and the selectivity to afford a desired partially oxidized product is very low even for low conversion.

### SUMMARY OF THE INVENTION

It is an object of the present invention to develop an electrochemical process for the partial oxidation of organic compounds.

This and other objects of the present invention have been satisfied by the discovery of a process for the oxidation of an organic compound in an electrochemical cell, comprising electrochemically oxidizing an organic compounds by contacting the organic compound with an anode material comprising a mixture of an electroconductive material and a mixed oxide of a metal of the 1st, 2nd or 5th main group and/or the 4th to 8th subgroup of the Periodic Table of the Elements, and contacting the cathode with an oxygen- or N₂O-containing gas.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 exemplifies the process of the invention wherein K is the cathode, A is the anode and E is the applied oxygen ion-conducting electrolyte.

FIG. 2 schematically illustrates an optional embodiment for optimizing temperature, current flow, current intensity and resistance time.

### DETAILED DESCRIPTION OF THE INVENTION AND PREFERRED EMBODIMENTS THEREOF

The present invention relates to a process for the oxidation of an organic compound in an electrochemical cell comprising anode, cathode and an oxygen ion-conducting solid electrolyte, wherein the organic compound is contacted with an anode comprising a mixture of an electroconductive material and a mixed oxide of the formula I

AₗBₘX⁷ₙX⁸ₒX⁹ₚX¹⁰_{q}X¹¹ᵣX¹²ₛOₜ (I)

where A, B=element of the 1st, 2nd and/or 5th main group and/or the 4th, 5th, 6th, 7th, 8th subgroup of the Periodic Table of the Elements,

X⁷=V, Nb, Cr, W, Ta, Ga and/or Ce,

X⁸=Li, Na, K, Rb, Cs, Be, Mg, Ca, Sr and/or Ba,

X⁹=La, Ce, Pr, Nd, Pm, Sm, Eu, Gd, Tb, Dy, Ho, Er, Tm, Yb, Lu, Cu, Ag, Au, Pd and/or Pt,

X¹⁰=Fe, Co, Ni and/or Zn,

X¹¹=Sn, Pb, Sb and/or Te,

X¹²=Ti, Zr, Si and/or Al, where

l=from 0.001 to 30,

m=from 0.001 to 20,

n=from 0 to 15,

o=from 0.001 to 10,

p=from 0 to 10

q=from 0 to 40

r=from 0 to 10, and

s=from 0 to 80 with the proviso that l+m≧0.01 and l+o≧0.005, and an oxygen- or an N₂O-containing gas is contacted with the cathode.

In formula I, the number of the oxygen atoms t is determined by the presence and valency of those elements other than oxygen.

Preferably, at least 25 wt % of the anode material mixture comprises the mixed oxide of the formula I.

Using the process according to the invention, many organic compounds can be oxidized selectively, such as aromatics, aliphatics, olefins, alicyclics or heterocyclics. In particular, the present invention is suitable for the oxidation of ethane, ethene, ethyne, propane, propene, propyne, butane, isobutane, butene, isobutene, butyne, butadiene, isoprene, pentane, pentene, pentadiene, hexane, hexene, hexadiene, cyclohexane, cyclohexene, cyclohexadiene, octane, octene, octadiene, cyclooctene, cyclooctadiene, vinylcyclohexane, vinylcyclohexene, cyclododecane, cyclododecene, cyclododecatriene, cyclododecanol, cyclododecanone, kimethylcyclohexanol, benzene, toluene, tert-butyltoluene, ortho-xylene, meta-xylene, para-xylene, cumene, cumylbenzene, cyclododecylbenzene, n-butylbenzene, ethylbenzene, tert-butylbenzene, methoxytoluene and phenoxytoluene. It is also possible, by using hydrocarbons, to produce synthesis gas, i.e. hydrogen plus carbon monoxide.

The addition of an electroconductive material to the anode material results in a distinct increase in the yield of the oxidation reaction. The specification of the electrical conductivity often makes use of the electrical volume resistivity (=VRest). This is measured in accordance with DIN IEC 93 and is specified in units of ohm·cm. Substances having a VRest of less than 108 ohm·cm, such as the metals, metal oxides, mixed metal oxides, perovskites and pyrochlore compounds employed according to the invention can preferentially be used. Preferably, the VRest is less than 106 ohm·cm, particularly preferably being less than 109 ohm·cm.

Whether this effect is really a matter of a change in the electrical conductivity of the anode or a matter of promotion of the transport of oxygen ions from the cathode through the solid electrolyte to the anode, or a matter of a temporary inhibition of the recombination of oxygen ions or a matter of a conversion of ambient oxygen to dissociated oxygen on the anode surface has not been ascertained, the important thing in all cases being that the VRest should be below 108 ohm·cm.

Electroconductive materials include perovskites, e.g. according to formula II (below), and pyrochloro compounds, e.g. according to formula III (below), metal oxides or metals, preferably copper, silver, gold, platinum, palladium and iridium.

If perovskites, e.g. according to formula II, or pyrochloro compounds are used, it may be advantageous to cover the top layer of the anode with a pure catalyst layer, i.e. without the addition of a conductive material, to minimize or preclude total oxidation.

The mixture of the mixed oxide according to formula I and the electroconductive material can be prepared by intensive mechanical blending. In general, a conventional mortar can be used for this purpose. However it is better to use commercial ball mixers, cone mixers, bead mills and other mixing equipment.

The term “mixed oxides” for the purpose of the present invention includes multimetal oxide compositions as metal oxides present next to one another. In any case, phase segregation is possible, depending on the stoichiometry and thermal treatment of the mixed oxides.

Mixed oxides of the abovementioned type are known from a different technical field, being used e.g. as heterogeneous catalysts for gas phase reactions. The preparation and the use of these compounds is described, e.g. in EP 0 417 723.

The use of mixed oxides of this type as heterogeneous catalysts is known in electroless chemical reactions. However, their use according to the invention as an anode material in electrochemical processes is not known. Mixed oxides suitable as an anode material for electrochemical processes include, inter alia, the following:

a) Mo_{9.57}Bi_{0.86}Fe_{6.4}CO_{3.2}K_{0.05} oxide

b) Mo₁₂Bi_{0.5}Fe₄CO₈Ca_{0.1}K_{0.1} oxide

c) Mo₁₂Bi₅Fe₄CO₈Ca_{0.1}K_{0.1} oxide

d) Mo₁₂Bi_{0.98}Ni_{6.34}Fe_{1.35}Zn_{1.35}Si₁₀K_{0.05}Na_{0.15} oxide

e) Mo₁₁V₄W₁Cu₂Sr_{0.5}Al₈ oxide

Also suitable are empirical formulae given for these mixed oxides having smaller subscripts in the empirical formula. For example, the mixed oxide c)=Mo₁₂Bi₅Fe₄CO₈Ca_{0.1}K_{0.1} oxide can be divided by the number 12, resulting in a product identical with the abovementioned empirical formula c): MoBi_{0.416}Fe_{0.33}CO_{0 66}Ca_{0.083} oxide. This means that an unambiguous statement in many cases is possible only on the basis of the ratio of the components present therein.

The anode itself can consist in its entirety or in part of the mixed oxides of the formula I and the added electroconductive material. Alternatively, an existing electrode, e.g. of platinum, can be equipped with a surface made of the these mixed oxides. In any case it is important, however, that the anode material, prior to application or a sintering process, be admixed with an electroconductive material such as e.g. metals, metal oxides or mixed metal oxides, so that at least the anode surface consists of a mixture of the mixed oxide and the electroconductive material.

In order to enhance the conductivity, the anode material can be admixed with a conductive metal such as e.g. copper, silver, gold, platinum, palladium and/or iridium and/or alloys of these. Since pure metals, however, can undergo chemical changes during the sintering process, the electroconductive material used is preferably a solid electrolyte according to the formula II or III or stabilized or nonstabilized cerium oxide or zirconium oxide.

In practice it has proved usefull first to apply a film comprising the mixed oxides and the electroconductive material to the electrolyte by means of a screen printing technique and to bond them by means of an annealing step. An example of this technique can be found in JP 09 239 956. Plasma spraying [Murphy, G. J.; King, H. W.; Atlantic Ind. Res. Inst., Halifax, NS, Can. J. Can. Ceram. Soc. (1985), 54, 14-20] is another option, as is the spraying of organic or aqueous suspensions [Miralaie, S. F.; Avni, R.; Francke, E.; Morvan, D.; Amouroux, J.; Nickel, H.; ENSCP, Laboratoire de Genie des Procedes Plasmas, 11 rue Pierre et Marie Curie, F-75231, Paris, France. Thin Solid Films (1997), 303 (1,2), 17-26].

In the process according to the invention, oxygen is taken up by the cathode and passed through the solid electrolyte through the anode. Alternatively, the cathode can be exposed to N₂O or an air stream or some other oxygen-containing off-gas stream. The important point is that this gas stream should include a gas such as oxygen or nitrous oxide which can be broken down by dissociation into oxygen anions which can migrate to the anode through the solid electrolyte.

The organic compound to be oxidized, optionally admixed with air and/or oxygen and/or an inert gas such as e.g. nitrogen, is passed along an anode of the above described type. The starting materials can be fed in as a gas or a liquid, although good utility at the reaction temperatures according to the invention is ensured by a gaseous feed. The effect when oxygen is employed in the anode compartment is particularly surprising, as air and/or oxygen which have not directly passed through the electrochemical cell are rendered utilizable for a selective oxidation by contact with the oxygen passing through the cell.

The oxygen ion-conducting solid electrolyte used in the process according to the invention can be a metal, mixed metal oxide or a metal oxide.

In particular embodiments of the present invention, the oxygen ion-conducting solid electrolyte or the electroconductive material used in the anode is a perovskite of the general formula II

LnₐX¹_{b}X²_{c}X³_{d}O₁₀ (II)

where

Ln=La, Ce, Pr, Nd, Pm, Sm, Eu, Gd, Tb, Dy, Ho, Er, Tm, Yb and/or Lu

X¹=Ca, Sr, Ba and/or Mg

X²=Ga, Al, Mn, Ti, Nb, Y, W and/or Zr

X³=Fe, Co, Ni and/or Cu

a=from 0.1 to 0.9,

b=from 0.1 to 0.9,

c=from 0 to 0.9,

d=from 0 to 0.9

with the proviso that a+b=from 0.3 to 1.5.

The number of the oxygen atoms o is determined by the valency and the presence of the elements other than oxygen in formula II.

Examples of other metal oxides suitable as oxygen ion-conducting solids or electroconductive materials include ZrO₂ or CaO—, Sc₂O₃—, Y₂O₃— and/or Yb₂O₃-stabilized ZrO₂ or CeO₂ or La₂O₃—, Y₂O₃—, Yb₂O₃— and/or Gd₂O₃-stabilized CeO₂.

The solid electrolyte can also comprise metals, preferably electroconductive metals such as copper, silver, gold, platinum, palladium and iridium and/or alloys of these, e.g. in the form of powders or flakes, or consist of these metals or alloys.

In further embodiments of the present invention, the oxygen ion-conducting solid electrolyte or electroconductive material used in the anode can comprise pyrochloro compounds of the general formula III

(LN_{f}X⁴_{g})₂(X⁵ₕX⁶ᵢ)₂Oₖ (III)

where

Ln=La, Ce, Pr, Nd, Pm, Sm, Eu, Gd, Tb, Dy, Ho, Er, Tm, Yb and/or Lu

X⁴=Na, Mg, Ca and/or Sr,

X⁵=Ti, Nb, Ta and/or Zr,

X⁶=Fe, Al, Sc, Ga and/or Y,

f=from 0.2 to 1.2,

g=from 0 to 0.8,

h=from 0.2 to 1.2,

i=from 0 to 0.8.

The number of the oxygen atoms k is again determined by the valency and the presence of elements other than oxygen in this formula.

These compounds can be prepared e.g. by means of sol-gel techniques [Shao Zonping; Sheng, Shishan; Chen, Hengrong; Li, Lin; Pan, Xiulian; Xiong Guoxing; State Key Laboratory of Catalysis, Dalian Institute of Chemical Physics, Chinese Academy of Science, Dalian, Peop. Rep. China. Gongneng Cailiao (1998), 29(Suppl), 1091-1093, 1096], spray-drying [Sizgek, E.; Bartlett, J. R.; Brungs, M. P.; Materials Division, Australian Nuclear Science and Technology Organization, Menai, Australia, J. Sol-gel Sci. Technol. (1998), 13(1/2/3), 1011-1016] or drip pyrolysis [P. Gordes et al., Den. J. Mater. Sci. (1995), 30 (4), 1053-8] or the composition methods (e.g.: N. Dhas et al., India J. Mater. Chem. (1993), 3 (12), 1289-1294, or D. Fumo et al., Port. Mater. Res. Bull. (1997), 32 (10), 1459-1470].

Also important for the conductivity is the make-up of the oxygen ion-conducting, solid electrolyte. The conductivity can be increased both via the composition on its own or via the geometry on its own or via the layer thickness on its own. Beneficial are layer thicknesses below 300 μm, preferably below 150 μm, especially preferably below 60 μm.

To increase the electrical conductivity it is also possible to arrange a metal foil between the oxygen ion-conducting solid electrolyte and the anode. Such metal foils can consist of a high-electroconductivity metal such as copper, silver, gold, platinum, palladium, iridium or an alloy or a mixture of these metals. The layer thickness of these metal foils should be below 250 μm, preferably below 100 μm, especially preferably below 50 μm.

The layer thickness of the solid electrolyte can be reduced by various methods, and the conductivity can be enhanced by e.g. CVD (=chemical vapor deposition), PVD (=physical vapor deposition), spin rotation or MOD spin casting [Swider, Karen Elizabeth. Univ. Pennsylvania, Philadelphia, Pa, USA. Avail. Univ. Microfilms Int., Order No. DA9308667. (1992); 242 PP: From: Diss. Abstr. Int. B 1993, 53(11), 5927], tape casting [Plucknett, Kevin P.; Caceres, Carlos H.; Wilkinson, David S.; Department Materials Science Engineering, McMaster University, Hamilton, ON, Can.; J. Am. Ceram. Soc. (1994), 77(8), 2137-44], slip casting [Forthmann, R.; Blass, G.; Buchkremer, H.-P. Forschungszentrum Julich GmbH, Julich, Germany. Editor(s): Sarton, L. A. J. L.; Zeedijk, H. B.; Mater. funct. Des., Proc. Eur. Conf. Adv. Mater. Processes Appl., 5th (1997), 3 3/271-3/274. Publisher: Netherlands Society for Materials Science; Zwijndrecht, Neth.] or especially also by the MOCVD method (=Metal-Organic Chemical Vapor Deposition). The latter method, by the composition on a porous substrate, allows the achievement of membrane thicknesses or, in the present case, electrolyte layer thicknesses, of between 1 μm and 50 μm. The method has been described by [O. Gorbenko, A. Kaul, A. Molodyk, V. Fuflygin, M. Novozhilov, A. Bosak, U. Krause, G. Wahl in “MOCVD of perovskits with metallic conductivity”, Journal of Alloys and Compounds, 251 (1997), 337-341].

The cathode used in the process according to the invention can be a metal such as copper, gold, silver, platinum, palladium, iridium or mixtures or alloys of these metals.

The cathode used can also be in the form of one or more metal oxides or a mixed metal oxide.

The term “mixed oxides” for the purpose of the present invention includes multimetal oxide compositions as metal oxides present next to one another. In each case phase segregations are possible, depending on the stoichiometry and thermal treatment of the mixed oxides.

Furthermore, the cathode used can be in the form of perovskites of the general formula IV

LaᵤX¹³ᵥX¹⁴_{w}X¹⁵ₓX¹⁶_{y}O_{3±z} (IV)

where

X¹³=Ce, Pr, Nd, Pm, Sm, Eu, Gd, Tb, Dy, Ho, Er, Tm, Yb and/or Lu,

X¹⁴=Ca, Sr, Ba and/or Mg,

X¹⁵=Mn, Fe, Ti, Ga, Mn and/or Zr,

X¹⁶=Co, Ni, Cu, Al and/or Cr

u=from 0to 1.2,

v=from 0to 1.0,

w=from 0.01 to 0.8,

with the proviso that a+v+w≦1.5,

x=from 0.2 to 1.3,

y=from 0 to 0.9,

with the proviso that x+y≧0.3.

The number of the oxygen atoms (3±z) is defined by the valency and presence of the elements other than oxygen.

DE-C-197 02 619 C1 describes the preparation of nonstoichiometric perovskites of the formula L_{α}M_{β}Mn_{χ}CO₈O₃ as a cathode material for high-temperature fuel cells. Fuel cells, however, have been developed for a different technical process, i.e. the production of electrical energy with total oxidation of a substrate.

The electrochemical oxidation of organic compounds according to the inventive process is carried out at elevated temperatures, preferably from 100 to 650° C., particularly preferably from 200 to 550° C.

The use of elevated pressures is likewise possible. Pressures of at most 100 bar, preferably from 1 to 20 bar, especially preferably 10 bar, can be applied.

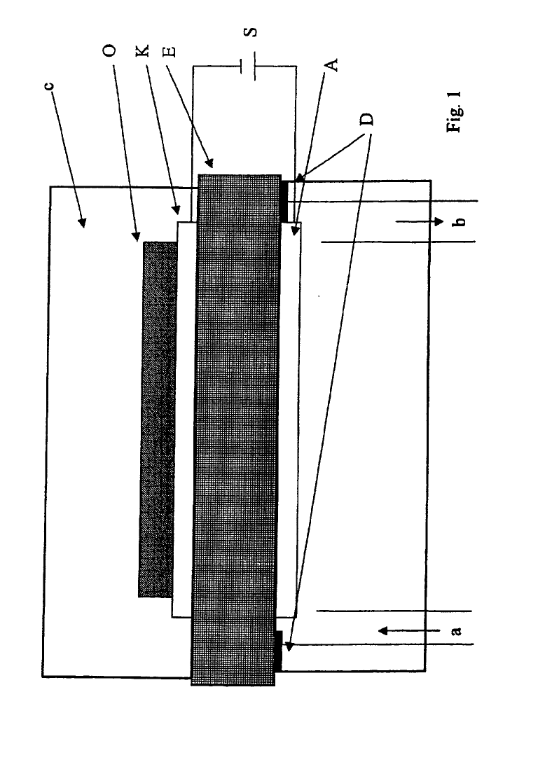

The process according to the invention, on the one hand, involves oxygen being converted at the cathode into an ionic form and being passed through the electrolyte to the anode and, on the other hand, being activated at the anode in such a way that a reaction takes place with the organic compound being passed along it. The oxygen can also be fed in through a porous, non-gas tight solid electrolyte. Apart from the organic compound to be oxidized and oxygen, the gas stream in the anode compartment can also contain an inert gas. An exemplary zone of an apparatus for carrying the process according to the invention is shown in FIG. 1.

The cathode K and the anode A are applied to the oxygen ion-conducting electrolyte E. Here it is important to ensure current-conducting bonding of the materials, e.g. by annealing. The two electrodes are supplied with current via the voltage source S.

Starting material and oxygen are passed onto the anode A as the gas stream a), the resulting product gas b) being discharged either as a result of the pressure of the gas stream a) or by means of a suitable negative pressure. The gas stream c) on the cathode side can consist of air, oxygen or some other oxygen-containing gas mixture and is discharged, depleted of oxygen.

The anode compartment is sealed against the electrodes by gold foils D. The oxygen supplier (about 10 kPa) is effected by the porous body O.

The spatial arrangement of anode, cathode and electrolyte is not limited to planar plates or continuous layers. Another option is that of using tubular reactors for the process according to the invention. In this case, either anode materials or cathode materials are applied to a tube made from the electrolyte. The necessary current leads require suitable adaptation.

As a further option, anode layer or cathode layer can be designed as a fabric or a patterned surface layer having regular recesses or projections.

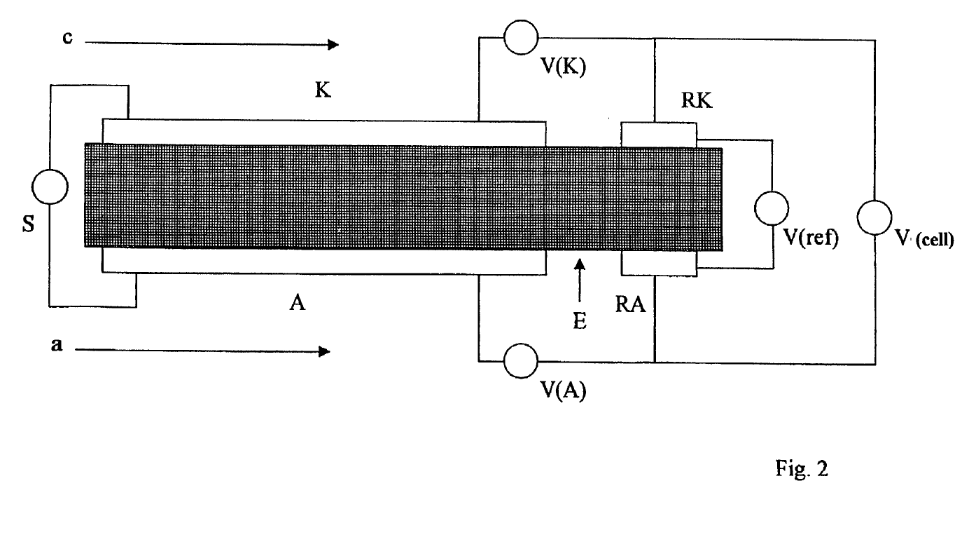

A suitable option for determining or optimizing the influence of the temperature, the current flow and the current intensity, which as a rule is between 0 and 100 mA, preferably from 10 to 20 mA, and the residence time, is provided by the experimental setup shown schematically in FIG. 2.

The current intensity depends on the size or production capacity of the cell used. The current intensities shown here relate to FIG. 2. The optimal current intensities for other cells have to be determined by experimental trials.

Suitable as a test apparatus, for example, is a current source S which can be programmed for various current flows and operates at a current intensity of from −100 to +100 mA. This involves monitoring of the over voltage at the anode A (V_{A}), the over voltage at the cathode K (Vₖ), the test cell voltage V_{cell} and the voltage Vₖ, V_{A} against the reference electrodes RA, RK, which can be made of platinum, for example.

In FIG. 2, E means oxygen ion-conducting solid electrolyte, a) starting-material gas stream (propene→acrolein), c) oxygen or oxygen-containing gas.

### EXAMPLES

Having generally described this invention, a further understanding can be obtained by reference to certain specific examples which are provided herein for purposes of illustration only and are not intended to be limiting unless otherwise specified.

Step a): Fabrication of the oxygen ion-conducting solid electrolyte

aa) Either commercial cerium oxide (from Indec b.v.) is used; or

ab) the desired compounds are used to prepare a suspension comprising a binder (e.g. 16 g of ethylcellulose, from Merck) and a solvent (e.g. 422 g of terpineol, i.e. p-menth-1-en-8-ol). This can be achieved, for example, with a ball mill or bead mill (from Netzsch), with a mixing time of 24 hours. Using this suspension, tape casting generates a thick film which, after the solvent has been stripped off or evaporated, affords a blank foil of the electrolyte. This is given the desired size by cutting.

In general it has been found that, depending on the electrolyte used, (the present experiments made use of La_{0.8}Sr_{0.2}Ga_{0.85}Mg_{0.15}O₂ and CeO₂), different layer thicknesses are expedient. In the case of La_{0.8}Sr_{0.2}Ga_{0.85}Mg_{0.15}O₂, a layer thickness of 80 μm was used, in the case of CeO₂ at a layer thickness of 200 μm. This foil is sintered (inserted between two porous aluminum oxide plates) for 6 hours at a temperature of 1500° C. (in the case of La_{0.8}Sr_{0.2}Ga_{0.85}Mg_{0.15}O₂) and at 1300° C. and for 8 hours (in the case of CeO₂).

Step b): Fabrication of the cathode

ba) to produce the cathode, a platinum layer is deposited on to the electrolyte; or

bb) a cathodic layer is fabricated as described in detail under c). The composition of the cathodic powder in this case is La_{0.6}Sr_{0.4}Fe_{0.8}Co_{0.2}O₃ (Rhône Poulenc). The sintering conditions in this case are 1 hour at 1100° C.

Step c): Fabrication of the anode/catalytic layer

The elements apart from molybdenum are dissolved with stirring in the form of their nitrate salts (from Merck) in accordance with the desired molar ratios in a VA propeller mixer in warm water at about 50° C. Molybdenum is initially dissolved separately as ammonium heptamolybdate 4-hydrate (NH₄)₆ Mo₇O₂₄×4H₂O (e.g. from H. C. Starck). The molar ratios of the elements relative to one another can be obtained e.g. from the table of Examples 1 to 3 or from formula I.

The ammonium heptamolybdate solution is poured, with stirring and in accordance with the desired molar ratio, into the nitrate salt solution introduced as an initial charge. A precipitation product is formed which redissolves with continued stirring and gels after a short time.

The gel is then dried at 110° C. in an air stream and then calcined at 450° C.

The material thus obtained is finally ground. The resulting powder can be used directly for the preparation of the catalytic paste.

The catalytically active paste is prepared by mechanical mixing (stirrer) of the catalyst powder, i.e. e.g. of the mixed metal oxide powder and the additive which enhances the electrical conductivity, with a cellulose-based excipient.

The excipient is prepared by mixing (20 minutes using a propeller stirrer) of 16 g of ethylcellulose (from Merck) in 422 g of terpineol (p-menth-1-en-8-ol). 32 g of catalyst and additives which enhance the electrical conductivity are initially mixed into 22 g of excipient by means of a spatula. Further mixing takes place by means of a three-roller mill (from Netzsch). This paste is collected in a 50 ml flask.

This paste is printed onto the electrolyte layer by means of a screen-printing apparatus (from DEK) and a mesh screen 53. Finally, the catalytically active layer is sintered for one hour at 400° C.

If, in addition, a metal foil is used between electrolyte and anode, the electrolyte is first covered with e.g. a gold foil having a layer thickness of 100 gm. Then the catalytically active layer is applied by screen printing.

1. Electrocatalytic oxidation of propene without the admixture of an oxygen-conducting, solid electrolyte to the anode (comparative example)

A porous catalytic film having a BET surface area of 17 m²/g is applied to an electrolyte foil made of CeO₂ by a screen-printing technique followed by annealing. Pt is vapor-deposited as a counter electrode. The reaction temperature is 400° C. A mixture of 5% propene and 95% nitrogen is passed across the anode at 2 1/h. Air is passed across the cathode at the same rate. The voltage applied to check the oxygen ion flux is 1 V. Results:

| Anode material (catalytic film) | Acrolein formation [mmol/h*g] |
|---|---|
| MoO₃ | 0.65 |
| Mo_{9.57}Bi_{0.86}Fe_{6.4}Co_{3.2}K_{0.05} oxide | 0.75 |
| Mo₁₂Bi_{0.5}Fe₄Co₈Ca_{0.1}K_{0.1} oxide | 0.90 |
| Mo₁₁V₄W₁Cu₂Sr_{0.5}Al₈ oxide | 0.70 |
| Mo₁₁V₄W₁Cu₂Sr_{0.5}Al₈ oxide plus | 0.65 |
| 100 μm gold foil between electrolyte | |
| and anode | |

2. Electrocatalytic oxidation of propene with the admixture of an oxygen-conducting, solid electrolyte to the anode (according to the invention)

A porous catalytic film having a BET surface area of 17 m²/g is applied to an electrolyte foil made of CeO₂ by a screen-printing technique followed by annealing. Pt is vapor-deposited as a counter electrode. The reaction temperature is 400° C. A mixture of 5% propene and 95% nitrogen is passed across the anode at 2 1/h. Air is passed across the cathode at the same rate. The voltage applied to check the oxygen ion flux is 1 V. Results:

| Anode material (catalytic film) | Acrolein formation [mmol/h*g] |
|---|---|
| MoO₃ | 1.80 |
| plus 10 wt % CeO₂ | |
| Mo_{9.57}Bi_{0.86}Fe_{6.4}Co_{3.2}K_{0.05} oxide | 2.50 |
| plus 25 wt % CeO₂ | |
| Mo₁₂Bi_{0.5}Fe₄Co₈Ca_{0.1}K_{0.1} oxide | 2.90 |
| plus 15 wt % La_{0.8}Sr_{0.2}Ga_{0.85}Mg_{0.15}O | |
| Mo₁₁V₄W₁Cu₂Sr_{0.5}Al₈ oxide | 3.25 |
| plus 10 wt % La_{0.8}Sr_{0.2}Ga_{0.85}Mg_{0.15}O | |
| plus 0.3 wt % Au powder (<100 μm) | |
| Mo₁₁V₄W₁Cu₂Sr_{0.5}Al₈ oxide | 2.65 |
| plus 10 wt % La_{0.8}Sr_{0.2}Ga_{0.85}Mg_{0.15}O | |
| plus 100 μm gold foil between | |
| electrolyte and anode | |

3. Electrocatalytic oxidation of propene with oxygen in the starting-material stream and with the admixture of an oxygen-conducting, solid electrolyte to the electrolyte (according to the invention)

A porous catalytic film having a BET surface area of 17 m²/g is applied to an electrolyte foil made of CeO₂ by a screen-printing technique followed by annealing. Pt is vapor-deposited as a counter electrode. The reaction temperature is 400° C. A mixture of 5% propene, 5% oxygen and 90% nitrogen is passed across the anode at 2 1 /h. Air is passed across the cathode at the same rate. The voltage applied to check the oxygen ion flux is 2 V. Results:

| Anode material (catalytic film) | Acrolein formation [mmol/h*g] |
|---|---|
| MoO₃ | 2.40 |
| plus 10 wt % CeO₂ | |
| Mo_{9.57}Bi_{0.86}Fe_{6.4}Co_{3.2}K_{0.05} oxide | 4.25 |
| plus 25 wt % CeO₂ | |
| Mo₁₂Bi_{0.5}Fe₄Co₈Ca_{0.1}K_{0.1} oxide | 3.60 |
| plus 15 wt % La_{0.8}Sr_{0.2}Ga_{0.85}Mg_{0.15}O | |
| Mo₁₁V₄W₁Cu₂Sr_{0.5}Al₈ oxide | 3.20 |
| plus 10 wt % La_{0.8}Sr_{0.2}Ga_{0.85}Mg_{0.15}O | |
| plus 0.3 wt % Au powder (<100 μm) | |
| Mo₁₁V₄W₁Cu₂Sr_{0.5}Al₈ oxide | 3.05 |
| plus 10 wt % La_{0.8}Sr_{0.2}Ga_{0.85}Mg_{0.15}O | |
| plus 100 μm gold foil between | |
| electrolyte and anode | |

The present application is based on German Patent Application No.10026941.9, filed with the German Patent Office on May 30, 2000, the entire contents of which are hereby incorporated by reference.

Obviously, additional modifications and variations of the present invention are possible in light of the above teachings. It is therefore to be understood that within the scope of the appended claims, the invention may be practiced otherwise than as specifically described herein.

1. A process for oxidation of an organic compound in an electrochemical cell comprising an anode, a cathode and an oxygen ion-conducting solid electrolyte, comprising:
contacting the organic compound with the anode, wherein the anode comprises a mixture of an electroconductive material and a mixed oxide of the formula I
AₗBₘX⁷ₙX⁸ₒX⁹ₚX¹⁰_{q}X¹¹ᵣX¹²ₛOₜ (I)
where
A, B=element of the 1st, 2nd and/or 5th main group and/or the 4th, 5th, 6th, 7th, 8th subgroup of the Periodic Table of the Elements,
X⁷=V, Nb, Cr, W, Ta, Ga and/or Ce,
X⁸=Li, Na, K, Rb, Cs, Be, Mg, Ca, Sr and/or Ba,
X⁹=La, Ce, Pr, Nd, Pm, Sm, Eu, Gd, Tb, Dy, Ho, Er, Tm, Yb, Lu, Cu, Ag, Au, Pd and/or Pt,
X¹⁰=Fe, Co, Ni and/or Zn,
X¹¹=Sn, Pb, Sb and/or Te,
X¹²=Ti, Zr, Si and/or Al, where
l=from 0.001 to 30,
m=from 0.001 to 20,
n=from 0 to 15,
o=from 0.001 to 10,
p=from 0 to 10
q=from 0 to 40
r=from 0 to 10, and
s=from 0 to 80
with the proviso that l+m≧0.01 and l+o≧0.005,
wherein said electroconductive material is other than said mixed oxide, and contacting the cathode with an oxygen- or an N₂O-containing gas.

2. The process as claimed in claim 1, wherein
the electroconductive material comprises metals, metal oxides or mixed metal oxides.

3. The process as claimed in claim 1, wherein
the electroconductive material is a perovskite of the general formula II
LnₐX¹_{b}X²_{c}X³_{d}Oₑ (II)
where
Ln=La, Ce, Pr, Nd, Pm, Sm, Eu, Gd, Tb, Dy, Ho, Er, Tm, Yb and/or Lu
X¹=Ca, Sr, Ba and/or Mg
X²=Ga, Al, Mn, Ti, Nb, Y, W and/or Zr
X³=Fe, Co, Ni and/or Cu
a=from 0.1 to 0.9,
b=from 0.1 to 0.9,
c=from 0 to 0.9,
d=from 0 to 0.9
with the proviso that a+b=from 0.3 to 1.5.

4. The process as claimed in claim 1, wherein
the electroconductive material is a pyrochloro compound of the general formula III
(LN_{f}X⁴_{g})₂(X⁵ₕX⁶ᵢ)₂Oₖ (III)
where
Ln=La, Ce, Pr, Nd, Pm, Sm, Eu, Gd, Tb, Dy, Ho, Er, Tm, Yb and/or Lu
X⁴=Na, Mg, Ca and/or Sr,
X⁵=Ti, Nb, Ta and/or Zr,
X⁶=Fe, Al, Sc, Ga and/or Y,
f=from 0.2 to 1.2,
g=from 0 to 0.8,
h=from 0.2 to 1.2,
i=from 0 to 0.8.

5. The process as claimed in claim 1, wherein
the electroconductive material is CeO₂ or La₂O₃—, Y₂O₃—, Yb₂O₃—, Gd₂O₃-stabilized CeO₂.

6. The process as claimed in claim 1, wherein
the electroconductive material is copper, silver, gold, platinum, palladium and/or iridium and/or alloys of these.

7. The process as claimed in claim 1, wherein
at least 25 wt % of the anode material comprises the mixed oxide of the formula I.

8. The process as claimed in claim 1, wherein
the oxygen ion-conducting solid electrolyte comprises cerium oxide (CeO₂) or lanthanum oxide-(La₂O₃—), yttrium oxide- (Y₂O₃—), ytterbium oxide-(Yb₂O₃—) and/or gadolinium oxide- (Gd₂O₃—) stabilized cerium oxide (CeO₂).

9. The process as claimed in claim 1, wherein
the oxygen ion-conducting solid electrolyte comprises zirconium oxide (ZrO₂) or calcium oxide-(CaO—), scandium oxide- (Sc₂O₃—), yttrium oxide-(YzO₃—) and/or ytterbium oxide- (Yb₂O₃—) stabilized zirconium oxide (ZrO₂).

10. The process as claimed in claim 1, wherein
the oxygen ion-conducting solid electrolyte is a metal, mixed metal oxide or metal oxide.

11. The process as claimed in claim 1, wherein
the oxygen ion-conducting solid electrolyte is a perovskite of the general formula II
LnₐX¹_{b}X²_{c}X³_{d}Oₑ (II)
where
Ln=La, Ce, Pr, Nd, Pm, Sm, Eu, Gd, Tb, Dy, Ho, Er, Tm, Yb and/or Lu
X¹=Ca, Sr, Ba and/or Mg
X²=Ga, Al, Mn, Ti, Nb, Y, W and/or Zr
X³=Fe, Co, Ni and/or Cu
a=from 0.1 to 0.9,
b=from 0.1 to 0.9,
c=from 0 to 0.9,
d=from 0to 0.9
with the proviso that a+b=from 0.3 to 1.5.

12. The process as claimed in claim 1, wherein
the oxygen ion-conducting solid electrolyte is a pyrochloro compound of the general formula III
(LN_{f}X⁴_{g})₂(X⁵ₕX⁶ᵢ)₂Oₖ (III)
where
Ln=La, Ce, Pr, Nd, Pm, Sm, Eu, Gd, Tb, Dy, Ho, Er, Tm, Yb and/or Lu
X⁴=Na, Mg, Ca and/or Sr,
X⁵=Ti, Nb, Ta and/or Zr,
X⁶=Fe, Al, Sc, Ga and/or Y,
f=from 0.2 to 1.2,
g=from 0 to 0.8,
h=from 0.2 to 1.2,
i=from 0 to 0.8.

13. The process as claimed in claim 1, wherein
disposed between the oxygen ion-conducting solid electrolyte and the anode is a metal foil having a thickness of at most 250 μm.

14. The process as claimed in claim 13, wherein
the metal foil comprises Cu, Au, Ag, Pt, Pd and/or Ir, a mixture or alloy of these metals.

15. The process as claimed in claim 1, wherein
the cathode comprises a metal.

16. The process as claimed in claim 15, wherein
the cathode comprises Cu, Au, Ag, Pt, Pd, Ir, a mixture or alloy of these metals.

17. The process as claimed in claim 1, wherein
the cathode comprises one or more metal oxides or a metal mixed oxide.

18. The process as claimed in claim 17, wherein
the cathode comprises a perovskite of the general formula IV
LaᵤX¹³ᵥX¹⁴_{w}X¹⁵ₓX¹⁶_{y}O_{3±z} (IV)
where
X¹³=Ce, Pr, Nd, Pm, Sm, Eu, Gd, Tb, Dy, Ho, Er, Tm, Yb and/or Lu,
X¹⁴=Ca, Sr, Ba and/or Mg,
X¹⁵=Mn, Fe, Ti, Ga, Mn and/or Zr,
X¹⁶=Co, Ni, Cu, Al and/or Cr
u=from 0to 1.2,
v=from 0to 1.0,
w=from 0.01 to 0.8,
with the proviso that a+v+w≦1.5,
x=from 0.2 to 1.3,
y=from 0 to 0.9,
with the proviso that x+y≧0.3.

19. The process as claimed in claim 1, wherein
the organic compound used is ethane, propane, ethene, ethyne, propene, benzene, toluene, butane, butadiene, butene, cyclohexane, octane and/or octene.

20. A process for oxidation of an organic compound in an electrochemical cell comprising a mixed oxide anode, a cathode and an oxygen ion-conducting solid electrolyte, comprising:
contacting the organic compound with the mixed oxide anode and contacting an oxygen or an N₂O-containing gas with the cathode, wherein the anode further comprises an electroconductive material, other than said mixed oxide.
